(19) United States
(12) Patent Application Publication
(10) Pub. No.: US 2006/0141231 A1
(43) Pub. Date: Jun. 29, 2006

(54) Underpad system

(76) Inventor: Alain Lemieux, Quebec (CA)

Correspondence Address: Brouillette & Partners, 1100 Rene-Levesque Blvd West, 23rd Floor, Montreal Quebec, QC, H3B 4N4, CA

(21) Appl. No.: 10/530,729

(22) PCT Filed: Oct. 11, 2002
(86) PCT No.: PCT/CA02/01533

§ 371 Date: Oct. 3, 2005

(51) Int. Cl. B32B 7/02

(52) U.S. Cl. 428/218

(57) ABSTRACT

This invention relates to an improved underpad system to be used underneath many types of surface coverings, such as synthetic turf, carpet, coating, tiles, etc. The system consists of three layers of material made from various components with different densities and thickness which provides a real absorption impact by a compression movement of the sandwiched layers.

### FIELD OF INVENTION

This invention relates to an improved underpad system to be used underneath many types of surface coverings and which consists of three layers of material made from various components with different densities and thickness.

### BACKGROUND OF THE INVENTION

In soccer or any other field sport, the characteristics of the field can affect the amount of physical stress experienced by players during a game or during training. A very hard and highly adhesive surface can provide players with more stability, but it can also increase the magnitude of the harmful forces and resistance conveyed to the musculo-skeletal system, and cause injuries such as turf toe or foot lock, to name a couple. On the other hand, a surface that is too soft can cause premature fatigue, and reduce a player's capacity to absorb impacts caused by the foot contacting the ground. An effective and safe playing field for soccer must have several key characteristics (absorption, recovery, stability, adhesion and ball behaviour, etc.) for young beginners, as well as for adults in elite leagues.

Studies indicate that between 61% and 90% of soccer injuries involve the lower limbs, specifically the knees and ankles. Most of these injuries are generally the direct result of excessive pressure at a specific point, or a delayed reaction to repeated physical stress over several months or years. 20% of short-term soccer injuries involve the ligaments, whereas long-term injuries stem from chronic inflammation of the tendons involved, and can sometimes cause degeneration (tendinitis). Among all players, those who suffer ligament problems have twice as much risk of another injury at the same site. One might be inclined to think that these types of injuries only involve high-level professional players. However, a Swedish study covering 600 players and 41 teams found that approximately two injuries occur for every 1,000 hours of soccer played, regardless of the level or age of the players.

Many factors can influence the rate of injuries, including interaction among players, their physical condition, the type of shoes worn, and the behaviour of the playing surface. This latter factor should always be adapted to the movements called for by the sport for which it is designed. In the case of soccer, the characteristics of the surface can affect the amount of physical stress experienced by players during the game and during training, because the shoes worn have limited shock-absorption capacity. A very hard surface can provide players with more stability when moving around, but can also amplify the force conveyed to the musculo-skeletal system. It has been suggested that injuries not caused by contact with another player are closely related to the playing surface and that repeated impact against a surface that is too hard can cause injuries such as the development of osteoarthritis and cartilage degeneration. On the other hand it is known that if the surface is too soft, it can cause premature player fatigue and reduce a player's ability to absorb the impact that occurs when their feet strike the surface.

A safe and efficient playing surface must have several key properties (absorption, recovery, stability, grip, etc.) that must be suitable for young beginners as well as adult players in elite leagues. Basketball, soccer, football, and baseball were the cause of more than 5,200 injuries to children age 14 or under who ended up in 15 hospitals across Canada in 1998. These statistics demonstrate the extent to which both youngsters and adults need safe athletic facilities in which to play their favourite sports.

In the past, most sport fields were made using a mix of rubber granules and sand to provide absorption and stability for the athlete, surface durability, and also uniformity and imitation of a natural surface for the ball behaviour. With time and repeated use, surfaces with rubber granules and sand become uneven as a result of the shifting of the granules. This instability results in ball behaviour becoming inconsistent, unpredictable, and very unsatisfactory.

Other sports field surfaces or floor systems have been developed in the past to incorporate the notions of an underpad system which provides a cushioned or shock absorbent surface on multi layers. For instance, Rone (U.S. Pat. No. 4,199,639) proposes a sandwich-structured double layer floor covering, comprising a polyethylene lower layer and an upper layer made of synthetic polymer fiber. Also, Di Geronimo (U.S. Pat. No. 5,605,721) uses a three layered structure made of different material to offer a shock absorbing underlayment for artificial playing surfaces method to fabricate the components.

In Jones et al. (U.S. Pat. No. 5,947,918), a top layer made of an elastomer and a bottom layer made of expended PTFE (polytetrafluoroetylene) provides an impact energy absorbing composite material with a controlled layer thickness relation.

This improved underpad system procures a high performance product of cushioning and shock absorbency by offering different level of absorption between light to very heavy impact and conserving a high comfortable stability for the ankles and knees for the human used, giving a “vertical suspension” providing protection (Skeletal trauma protection, reduces fatigue dispersing vertical impact) and energy return for competitive play according to the normal playability required.

The underpad system's absorption performances procures a very stable surface, adapted for any kind of subject of any age or any weight, which is only made possible by the application of the layered system. It can also be used for machinery equipment such as an helicopter landing surface support, since this “sandwich” system procures a very good shock absorbency in case of a very good or more difficult landing event for an helicopter.

### SUMMARY OF INVENTION

The object of this invention is to provide an innovative improved underpad which consists of three layers of material made from various components with different densities and thickness.

The underpad improved system offers a very high cushioning performance that can be used underneath any type of surfaces to give them a superior shock absorbency property than any existing surfaces including the natural grass without loosing any stability and energy.

There is therefore provided an underpad system with enhanced impact and shock absorbency properties which comprises:
a top layer made of a first compressible material having a first thickness and a first density;
a middle layer made of a second compressible material having a second thickness and a second density;
a bottom layer made of a third compressible material having a third thickness and a third density;
wherein said middle layer is compressed before said top layer and said bottom layer for low impact and shocks, and the said first thickness and the said third thickness remains the same.

There is further provided an underpad system with enhanced impact and shock absorbency properties which comprises:
a top layer made of extended polypropylene having a first thickness and a first density;
a middle layer made of polyurethane foam having a second thickness and a second density;
a bottom layer made of extended polypropylene having a third thickness and a third density.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF FIGURES

FIG. 1a is an isometric view of the improved underpad system in accordance with the invention;

FIG. 1b is schematic side view showing the sandwiched layers of the underpad system shown in FIG. 1.

FIG. 2a is a side view showing a soccer ball rolling on top of the underpad system shown in FIG. 1.

FIG. 2b is a side view showing a soccer ball bouncing on top of the underpad system shown in FIG. 1.

FIG. 3a is a side view showing a soccer player's feet, in a running condition, on top of one of the prior art system.

FIG. 3b is a side view showing a soccer player's feet, in a running condition, on top of the underpad system shown in FIG. 1.

FIG. 4a is a side view showing a soccer player's feet, in a sideways movement, on top of one of the prior art system.

FIG. 4b is a side view showing a soccer player's feet, in a sideways movement, on top of the underpad system shown in FIG. 1.

FIG. 5a is a side view showing a soccer player's feet, in a sideways and rotation movement, on top of one of the prior art system.

FIG. 5b is a side view showing a soccer player's feet, in a sideways and rotation movement, on top of the underpad system shown in FIG. 1.

### DETAILED DESCRIPTION OF A PREFERRED EMBODIMENT

The new underpad system consist of a “sandwich” design comprising 3 layers of different densities, thickness and components of any type of cushion and absorbent material, such as but not limited to: EPP products (expanded and/or extruded polypropylene close cell beads molded into an open cell structure), foam products, EPE product (expanded and/or extruded), EPDM products, crumb rubber tire products, plastic products, natural and or synthetic rubber products and polyurethane products.

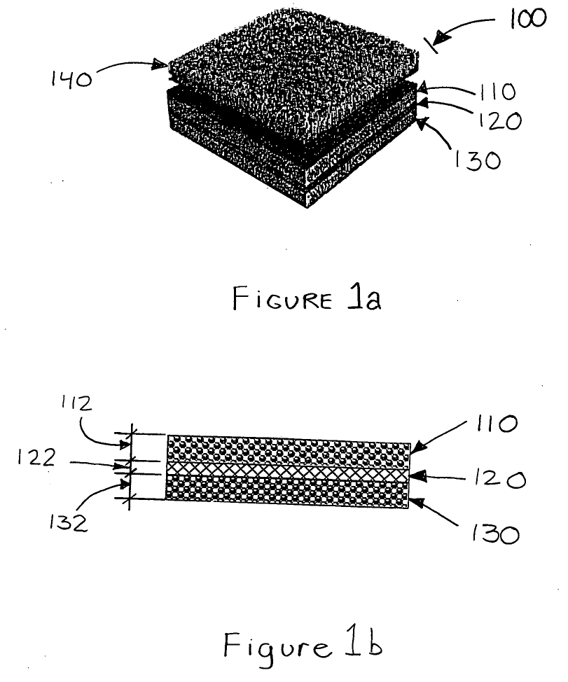

As seen in FIGS. 1a and 1b, the underpad system 100 comprises a top layer 110, a middle layer 120 and a bottom layer 130. The artificial turf 140 is fixed on top of the top layer 110.

The top 110 and the bottom layer 130 have to be made out of a denser and a more rigid material than the middle layer 120, to allow the top layer 110 to be compressed partially or totally on the bottom layer 130, which provides an adding shock absorbent effect by the compression movement of the top layer 110 on the bottom one 130. The top layer 110 comprises a thickness 112 and a density that may or may not be the same as the bottom layer 130 thickness 132 and density, depending of the utilization and the shock absorbent quality which is desired. The top layer 110 must be having by itself some deflection properties to absorb light impact but enough firm to procure very high stability characteristics combined with the desired standing and walking feeling.

The middle layer 120 has also to be lighter and softer but depending of the utilization of the underpad system 100, its thickness 122 and density will be specifically designed to allow the right speed and quantity of compression and reflection of the top layer 110, which is necessary to get the specific shock absorption effect described herein.

The bottom layer 130 could also have a different density and thickness 132 depending of the utilization and the shock absorbent quality which desired. The bottom layer 130 must be having by itself great properties to entirely absorb the final energy of an heavy impact but firm enough to procure a very high structural to the entire system.

In a first embodiment, the underpad system 100 can be used in a synthetic soccer field application. The sandwiched layers (110, 120 and 130) are constituted from a top layer 110 made of EPP product of a medium density (1.9 pound per cubic feet) and having a thickness (112) of 15 mm. The middle layer 120 is made of open cell polyurethane foam (1.9 pound per cubic feet) having a thickness (122) of 10 mm and lastly, the bottom layer 130 is the same as the top layer 110, being made of EPP product of a medium density (1.9 pound per cubic feet) and having a thickness (112) of 15 mm of thickness.

The top 110 and bottom 130 layer are designed for optimal multidirectional absorption of the impact of running or falling to the ground. They provide constant stability for the ankle throughout the game and the season. Layers (110, 120 or 130) density can be adjusted in order to customize the surface for many other sports like American football, rugby and also for all types of players weight and size. The middle layer 120 has a very low density and resistance system that is designed solely to absorb the ball bounces without interfering with the top and bottom layer (110 and 130). Also, when the athlete touches the surface, this layer 120 is completely compressed because of its low resistance. The athlete's stability is ensured by the two touching top and bottom layers (110 and 130).

That combination gives the right stability for the player which protects him against injury to his ankles, knees, or elbows, with a minimum of cost of energy. The underpad system 100 performance offer a better shock absorbency performance on an heavy impact for an adult (15 to 20%) and for children or teenagers (over 30%) than any other surfaces including the natural grass.

This new design in sandwiched combination of layers (110, 120 and 130) uses different kind of proper cushion material already existing. These materials specifically combined together allow a maximum of shock absorbency without affecting the stability of the surface and without causing any adding energy cost. Usually, a very absorbent surface is made with a very soft product which is very unstable and too soft to walk, run and play normally. These products cost more energy because the deflection of the product is too big, which could be compared as walking on a sand beach versus walking on the natural ground.

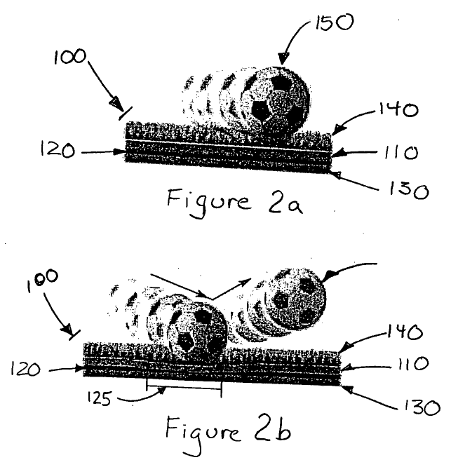

FIGS. 2a and 2b illustrates how the soccer ball behaves when the underpad system 100 is installed on a soccer field. As the ball 150 rolls on the artificial turf 140, no structural shifting nor compression occur on any layer (110, 120, or 130). When the ball 150 hits the turf 140 at an angle, it bounces back and compresses an area 125 of the middle layer 120, because of its lower resistance.

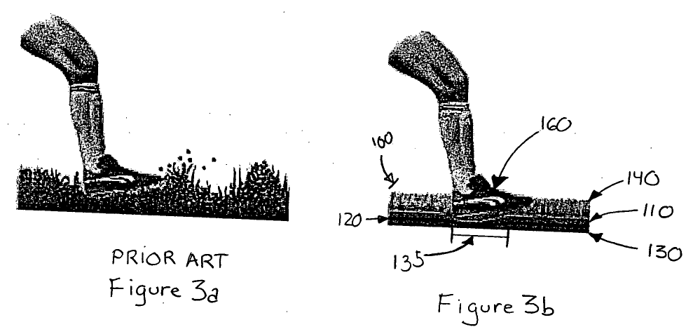

The multidirectional absorbent and stabilizing capacity of polypropylene for the impact of a running foot is shown in FIG. 3b. The compression area 135 absorbs the energy coming from the hit of the running foot 160, with the top 110 and middle 120 layers being compressed and temporarily deformed, but the bottom layer 130 deforms only slightly. FIG. 3a illustrates one case of a prior art system with granules which shift and, unless compressed, lose all absorbent capacity and stability.

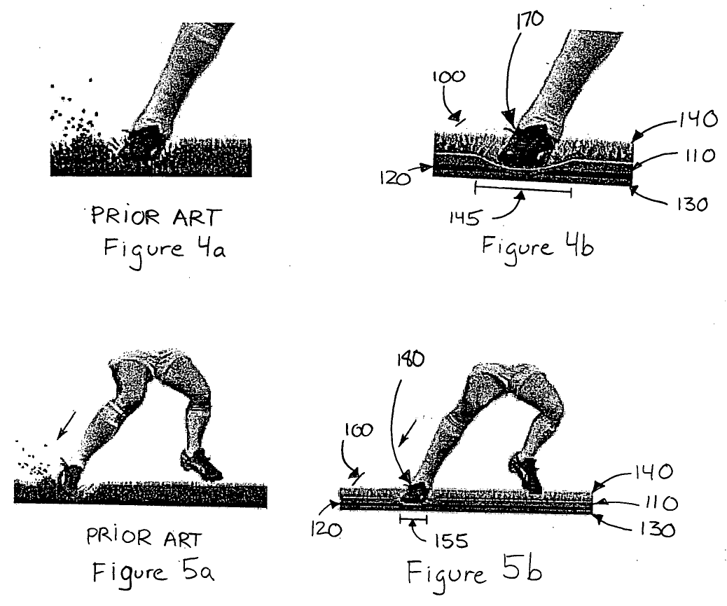

FIGS. 4a and 5a show a soccer player's foot, in a sideways movement with or without a rotation movement, on top of one of the prior art's field system which comprises granules. The multidirectional absorbent and stabilizing capacity of the underpad system 100 is illustrated in FIG. 4b and 5b for the same sideways movement with or without rotational movements. In both case, the soccer player's foot (170, 180) creates the compression area (145 and 155) which absorbs the energy by the temporary deformation of the top 110 and middle 120 layer, and the partial deformation of the bottom layer 130.

While a preferred embodiment of the invention has been described herein, it should be apparent to those skilled in the art that variations and modifications are possible without departing from the spirit of this invention.

1. An underpad system with enhanced impact and shock absorbency properties which comprises:
a top layer made of a first compressible material having a first thickness and a first density;
a middle layer made of a second compressible material having a second thickness and a second density;
a bottom layer made of a third compressible material having a third thickness and a third density;
wherein said middle layer is compressed before said top layer and said bottom layer for low impact and shocks, and the said first thickness and the said third thickness remains the same.

2. An underpad system, as claimed in claim 1, wherein said first and third material is the same.

3. An underpad system, as claimed in claim 2, wherein said second material is more easily compressed than said first material and said third material.

4. An underpad system, as claimed in claim 1, wherein the said top layer is compressed before the said bottom layer.

5. An underpad system, as claimed in claim 1, wherein the said bottom layer absorbs the excess impact and shock that is not absorbed by the said middle and the said top layer.

6. An underpad system with enhanced impact and shock absorbency properties which comprises:
a top layer made of extended polypropylene having a first thickness and a first density;
a middle layer made of polyurethane foam having a second thickness and a second density;
a bottom layer made of extended polypropylene having a third thickness and a third density.

7. An underpad system, as claimed in claim 6, wherein the said first thickness is equal to the said third thickness.

8. An underpad system, as claimed in claim 6, wherein the said first density is equal to the said third density.

9. An underpad system, as claimed in claim 6, wherein the said top layer is the same as the said bottom layer.
